(19) United States
(12) Patent Application Publication
(10) Pub. No.: US 2009/0006172 A1
(43) Pub. Date: Jan. 1, 2009

(54) SYSTEM AND METHOD FOR PROVIDING WORKFLOW MONITORING

(75) Inventors: Amit SINGH, Irving, TX (US); Fariborz Ebrahimi, Arlington, VA (US); Dinyar Kavouspour, Plano, TX (US); Abhijit Adhyapak, Irving, TX (US); Srinivas Halembar, Irving, TX (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Data Services Inc., Temple Terrace, FL (US)

(21) Appl. No.: 11/771,093

(22) Filed: Jun. 29, 2007

(51) Int. Cl. G06Q 10/00

(52) U.S. Cl. 705/9; 705/7

(57) ABSTRACT

An approach is disclosed for providing a workflow monitoring system. Monitoring is performed for a non-occurrence of a successful movement by an object through a workflow that includes a plurality of activities. A task corresponding to the object is generated to specify non-movement through the workflow.

### BACKGROUND INFORMATION

To be competitive, businesses are continually seeking to improve their business processes. Towards this end, the businesses must examiner their business workflows for inefficiencies. A typical business workflow involves service ordering, which can be quite complex, as taking and fulfilling an order entails the interaction of many users across many departments within the organization. Given the many avenues for an organization to process orders (e.g., online, snail mail, physical store, etc.), streamlining the workflow and handling exception conditions are vital.

For example, with the ever expansive growth of the Internet, e-commerce continues to provide an appealing option for consumers who would like to order services and products from the comfort of their own homes or offices. Once a customer places an order regarding a product or service, it is the responsibility of the vendor to ensure that the product arrives at the customer's premises in a timely manner. This, however, involves the use of sophisticated order tracking and management schemes. Successful, consistent and accurate order tracking and management is a significant challenge faced by companies in a variety of sectors, including telecommunications, manufacturing, etc.

As companies introduce sophisticated offerings (e.g., bundled products), order management becomes even more daunting task for the duration of the order life cycle, which includes the creation of the order and subsequent generation of billing information. The process also increases in complexity if the order encounters multiple exceptions during its life cycle. Once an order is placed, the order is processed through various stages of its life cycle, including contacting third party vendors, locating products in warehouses, shipping the product, etc. Due to the many phases of a typical order life cycle, there is a high probability that issues and problems (i.e., exceptions) arise during one or more of these phases, resulting in the suspension of the order at some point in the life cycle.

Traditionally, issues relating to order tracking have been the responsibility of call center agents. These agents are charged with making sure that a customer is given the necessary information regarding the customer's order and that such order is provisioned as promised. Placing this responsibility to customer service agents can be a time consuming endeavor for the agent, translating into significant costs to the company. As the volume of orders accumulates, this manual approach for order tracking becomes more inefficient and ultimately failing, thereby becoming a cause of dissatisfaction at the customer's end due to the agent not being able to supply the necessary information to the customer in a timely manner. Furthermore, assigning service agents to manually perform order tracking and management requires training the agents in various processes, which is also costly for the company.

Based on the foregoing, there is a clear need for efficiently monitoring workflows.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a monitoring system capable of proactively monitoring a workflow, according to various exemplary embodiments;

FIG. 2 is a flowchart of a process for proactively monitoring a workflow, according to an exemplary embodiment;

FIG. 3 is a diagram of components of the monitoring system of FIG. 1, according to various exemplary embodiments;

FIG. 4 is a flowchart of an exemplary process for applying the monitoring system of FIG. 1 to service orders, according to an exemplary embodiment;

FIG. 5 is a flowchart of a process for handling service orders, according to an exemplary embodiment; and

FIG. 6 is a diagram of a computer system that can be used to implement various exemplary embodiments.

### DETAILED DESCRIPTION OF PREFERRED EMBODIMENTS

An apparatus, method, and software for providing proactive exception monitoring and task management are described. In the following description, for the purposes of explanation, numerous specific details are set forth in order to provide a thorough understanding of the various exemplary embodiments. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various embodiments of a workflow monitoring system are described with respect to service orders, it is contemplated that these embodiments have applicability to other objects and business processes.

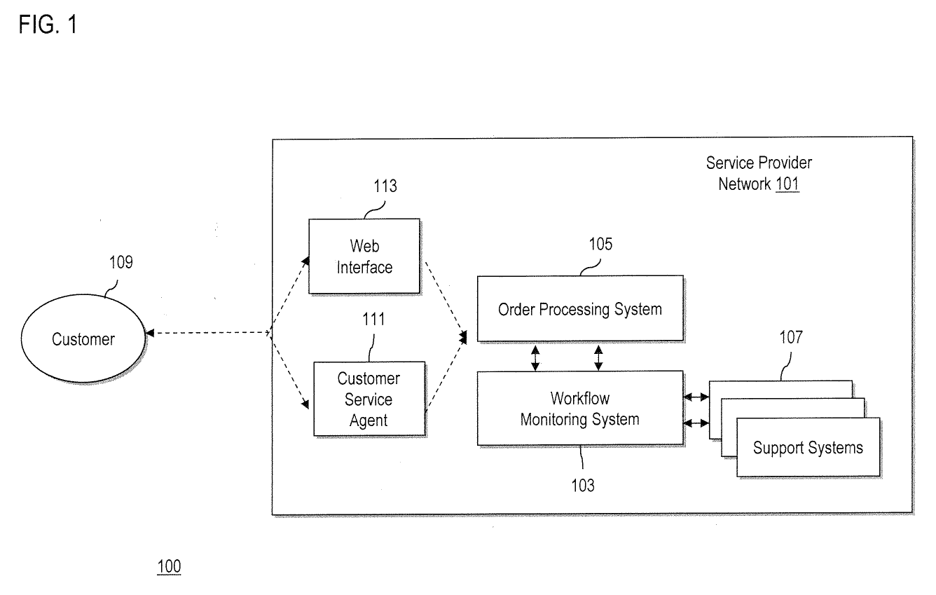

FIG. 1 is a diagram of a monitoring system capable of proactively monitoring a workflow, according to various exemplary embodiments. A communication system 100, by way of example, supports management of workflows by a service provider to its customers. A service provider network 101 employs workflow monitoring system 103 that interacts with an order processing system 105. It is contemplated that this system 105 can be tailored to process various items, depending on the particular application. The workflow monitoring system 103 provides the ability to automate and orchestrate repetitive workflows, as well as track orders through the workflows. In particular, the workflow system 103 offers users an overview of their work and associated events; that is, the system 103 supports an application that shows the status and progress of each job and links to relevant applications that enable the users to perform their tasks and advance the project towards completion.

Traditional workflow systems track exceptions in queues that require manual intervention. It is, however, not sufficient to just track exceptions due to the high probability that certain orders might not conform to predefined order rules and may get bogged down in the order queue. There is a high chance that these orders will be overlooked or forgotten, as they will not be in any of the fallout queues. As a result, this conventional mode of tracking has many inherent “blind spots.” These blind spots can result in failure by the company to meet its commitment to the customer, causing a drop in customer satisfaction ratings and ultimately loss of revenue.

In an exemplary embodiment, the system 105 handles service orders corresponding to the services and/or products offered by the service provider. The workflow monitoring system 103, unlike conventional workflow systems, provides proactive exception monitoring and task management. The system 103 can interface with various support systems 107, which can include various organizations or teams (e.g., order monitoring team, exception or task handling team, dispatch team, etc.). This “pipeline transparency” approach, in contrast to monitoring occurrence of issues as common in traditional approaches, monitors non-occurrence of successful movement through the workflow during specific timeline or reference events, thus eliminate chances of “blind spots”—i.e., exception conditions that are not readily discoverable or detected. This shifts from traditional “queue based tracking” to “business milestone” tracking.

The workflow monitoring system 103 can define, create, and manage the execution of workflow through the use of software, running on one or more workflow engines (not shown), which are able to interpret the process definition, interact with workflow participants and, where required, invoke the use of information technology (IT) tools and applications. In an exemplary embodiment, the workflow monitoring system 103 can be generic in that it does not depend on workflow management products of any particular vendors and can be employed in any software system that has workflow functionalities, such as order entry and provisioning systems.

The workflow engines, in one embodiment, manage and execute modeled business processes. In addition, the workflow engines may interpret the process definitions, and interact with workflow participants. In this example, workflows and associated activities are related to the service provider for service order processing. A workflow relates to executing one task following another in accordance with specific business rules and conditions. The resultant information from the analysis accessible by a user of the support team 107 via, in an exemplary embodiment, a browser application (e.g. Microsoft Internet Explorer™, or Netscape™, etc.), which is resident on a computing device, which can include a desktop personal computer, or any device capable of supporting a browser application—e.g., Personal Digital Assistant (PDA), web appliance, cellular phone, laptop, etc.

In an exemplary scenario, a customer 109 places an order for a product or service by either directly interacting with a customer service agent 111 or via a direct interface (e.g., web interface) 113, for example. The customer 109 can access the service provider network 101 through any a number of networks and access technologies. Information regarding the order is processed via the order processing system 105. The order processing system 105 in turn feeds data to the proactive exception monitoring/task management system 103, which operates in conjunction with the support teams 107 to ensure that the life cycle of the order is completed.

As noted, the workflow monitoring system 103 can overcome the blind spots that may arise during the exception monitoring phase by proactively monitoring all the successful or business driven order milestones. This is accomplished by integrating all support systems that are part of the order life cycle in real-time and furthermore understanding the timeline and reference events that a business wants to track in the order life cycle. By monitoring these events in real-time, the monitoring system 103 can determine whether the orders are progressing through the various systems. In this manner, rather than waiting for a notification from these other support systems of a failure or an exception condition, the system 103 creates a “task,” “exception,” or “work item” to alert the agent in charge of monitoring. For example, the alert may be generated in case an order has not moved from a particular system within a predetermined period of time. In other words, a task is created if successful movement of the milestones in the workflow life cycle is not achieved.

By proactively monitoring, tracking and managing orders from beginning to end, through all the phases of all the systems involved within the order life cycle, successful completion of the order life cycle is achieved. This approach enables the customer to be served efficiently and in a timely manner, thereby improving customer satisfaction and retention.

The operation of the monitoring system 103 for proactive workflow monitoring is explained as follows.

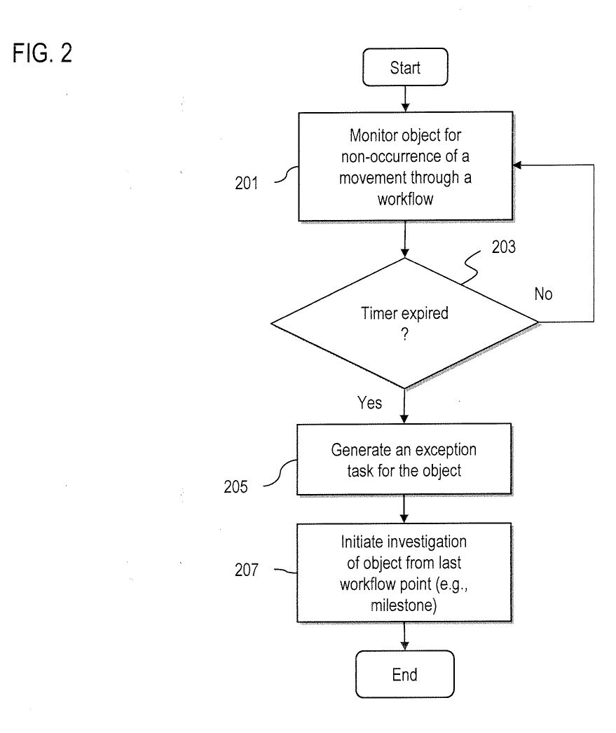

FIG. 2 is a flowchart of a process for proactively monitoring a workflow, according to an exemplary embodiment. In step 201, an object, such as a service order or a ticket, is monitored for non-occurrence of a successful movement (or progress) through a workflow. The monitoring system 103, in an exemplary embodiment, provides a view of the order; the view, for example, can include customer details and the timeline of events or milestones that the order has undergone.

The process determines, per step 203, whether a timeout period, as captured by a timer, has elapsed. If the timer has expired, a task (or work item) is generated, as in step 205, for alerting the fact that the object has experienced an exception condition that is preventing the object from reaching the next point in the workflow. In step 207, investigation is initiated for the object to resolve the exception condition.

In a call center application, for instance, the call center agents (e.g., agent 111) or order control groups monitor these work items which are only a few in comparison to the number of orders placed. This approach enables the agent to track events that took place for any particular order; accordingly, the agent may start investigating the history of the order from the system where the last business milestone took place, for instance. The issue that a particular order faces in the native system may consequently be resolved. Once the order is fixed or resolved, the order starts flowing through the order system 105 and a notification of its movement can be issued. In an exemplary embodiment, this monitoring process occurs throughout the life cycle of the order.

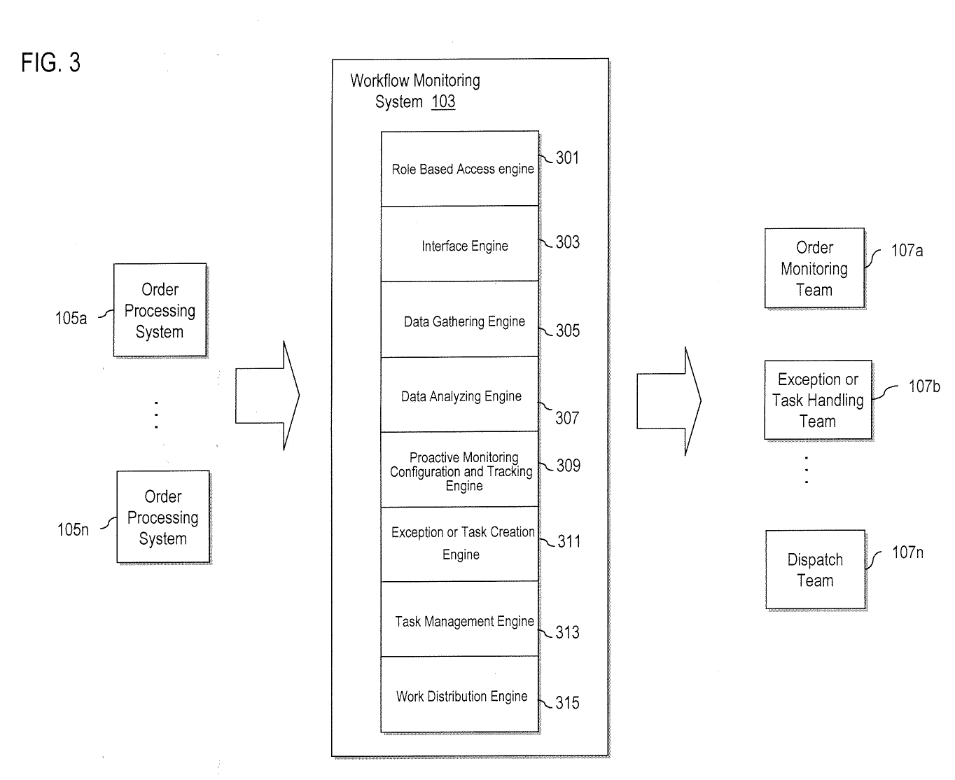

FIG. 3 is a diagram of components of the monitoring system of FIG. 1, according to various exemplary embodiments. In this example, the order processing system 105 of FIG. 1 is shown as comprising multiple systems 105a-105n that may perform separate and distinct functions of an order workflow. As shown, the monitoring system 103 utilizes the following components: an role based engine 301, an interface engine 303, a data gathering engine 305, a data analyzing engine 307, a proactive monitoring configuration and tracking engine 309, an exception or task creation engine 311, a task management engine 313, and a work distribution engine 315. It is noted that other components can be utilized or omitted, depending on the particular workflow systems that are supported. The monitoring system 103 conveys tasks or work items to the support teams 107a-107n, which can include an order monitoring team, an exception or task handling team, or a dispatch team. Each team hence has its various roles in the completion of the order life cycle.

Table 1 enumerates the functions of the components 301-315:

TABLE 1

| COMPONENT | DESCRIPTION |
|---|---|
| Role Based Access Engine 301 | Defines the privileges and |
| | functionalities of each role and |
| | which users within the support teams |
| | 107a-107n are part of that role |
| Interface Engine 303 | Has responsibility for building real- |
| | time interfaces -- such as MQ, Web |
| | service, Java Message Service |
| | (JMS), Extensible Markup Language |
| | (XML) over HyperText Transfer |
| | Protocol Secure (HTTPS), Secure |
| | File Transfer Protocol (sFTP) etc. |
| | and; receiving and sending |
| | messages (i.e., information about the |
| | order milestone sent by order |
| | processing systems 105a-105n) |
| | about order details and milestones |
| Data Gathering Engine 305 | Gathers, validates the received data |
| | regarding the order against the |
| | schema, interprets and applies |
| | interface logic and reformats the |
| | data and stores them in a database |
| Data Analyzing Engine 307 | Analyzes the data from various |
| | systems (e.g., system 105a-105n) |
| | and translates the data into business |
| | milestones |
| Proactive Monitoring | Captures the user defined business |
| Configuration and Tracking | rules such as region (e.g., customer |
| Engine 309 | geographical region), state, |
| | milestones, due date (e.g., date when |
| | the customers order needs to be |
| | provisioned or enabled), hours etc. |
| | and invokes monitoring component |
| | at user defined intervals. The engine |
| | 309 also applies the business rules |
| | defined for the orders in the |
| | monitoring system 103. In an |
| | exemplary embodiment, this |
| | component 309 applies the rules |
| | (which can be defined dynamically). |
| Exception or Task Creation Engine | When an order satisfies the proactive |
| 311 | monitoring rules, exception or task |
| | creation engine is invoked. Task |
| | creation engine 311 creates a task to |
| | indicate that the order has an issue |
| | and chances of missing the order due |
| | date. The task will be worked by the |
| | order monitoring team 107a, fallout |
| | team or any other team responsible |
| | for tracking the orders. |
| Task Management Engine 313 | Manages activities associated with |
| | the tasks, such as adding remarks, |
| | Transfer, Assign, Complete, and |
| | Holding tasks. This engine 313 also |
| | closes the task if there is a milestone |
| | movement of the orders. |
| Work distribution Engine 315 | Provides user the capability to define |
| | algorithms or set of rules based on |
| | which the tasks can be assigned to |
| | the team 107 who are responsible to |
| | work on them. |

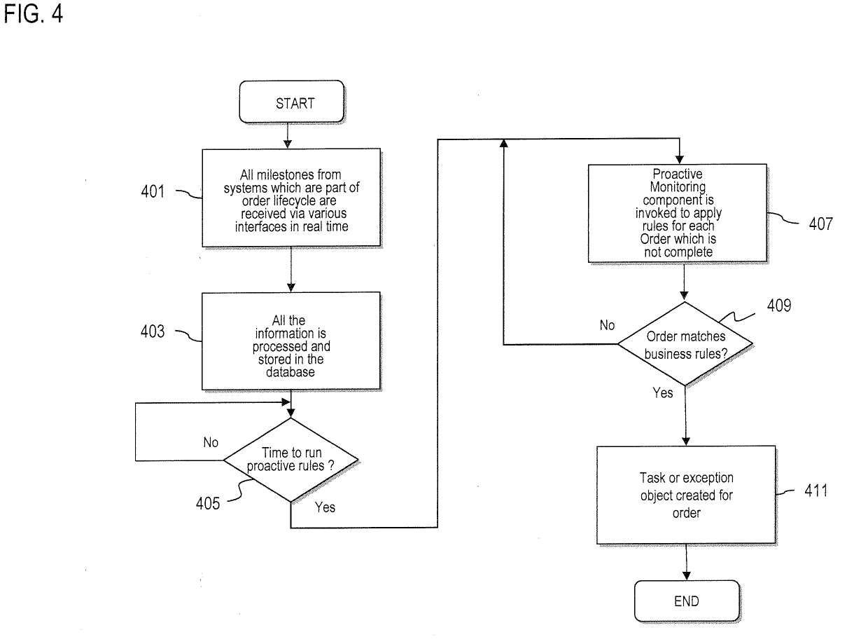

All the systems (e.g., processing systems 105) involved in the life cycle of an order send messages as per their respective interface definition. After validating the data against an agreed upon schema, the reformatted data is stored in a database (not shown) of the monitoring system 103 in respective tables. The monitoring engine 309 can be configured to run at a specified interval. Based on its specific configuration, the monitoring engine 309 runs at scheduled intervals and applies the dynamically configurable business logic against all orders in the database. If an order satisfies the business rules, the task creation engine 311 creates a task and continues until all the orders are verified in the system 103. The processes involved in proactively generating an exception item are more fully described below with respect to FIG. 4.

FIG. 4 is a flowchart of an exemplary process for applying the monitoring system of FIG. 1 to service orders, according to an exemplary embodiment. In step 401, all milestones from the order processing systems 105 that are part of the order life cycle are transmitted to the monitoring system 103 via various interfaces over the interface engine 303 in real-time. By way of example, “milestones” can be defined to be any indications of an event regarding an object (e.g., order). A milestone can be either a status, a fallout or an alarm (i.e., an indication on the order if it is probable of missing the order due date). “Status” can be defined to be the successful state of the order, and fallout is defined to be the unplanned manual handling of the order.

All the information that is gathered is processed and stored in a database, as in step 403.

In step 405, the process determines whether to run the proactive rules. If it is not the appropriate time to execute the rules, then the processes are suspended until the appropriate time. Otherwise, if it is the appropriate time, then the proactive monitoring engine 309 is invoked to apply the rules for each order that is not completed, per step 407.

Thereafter, the process determines whether the order matches the business rules, as in step 409. If the order does not match the business rules, then the task or exception object is created, per step 411, and the process terminates. If, on the other hand, the order does match the business rules, then the proactive monitoring engine 309 is invoked again to apply the rules for each order that is not complete. This process continues until either the order is complete or a task/exception object is created (whenever the order does not match the business rules).

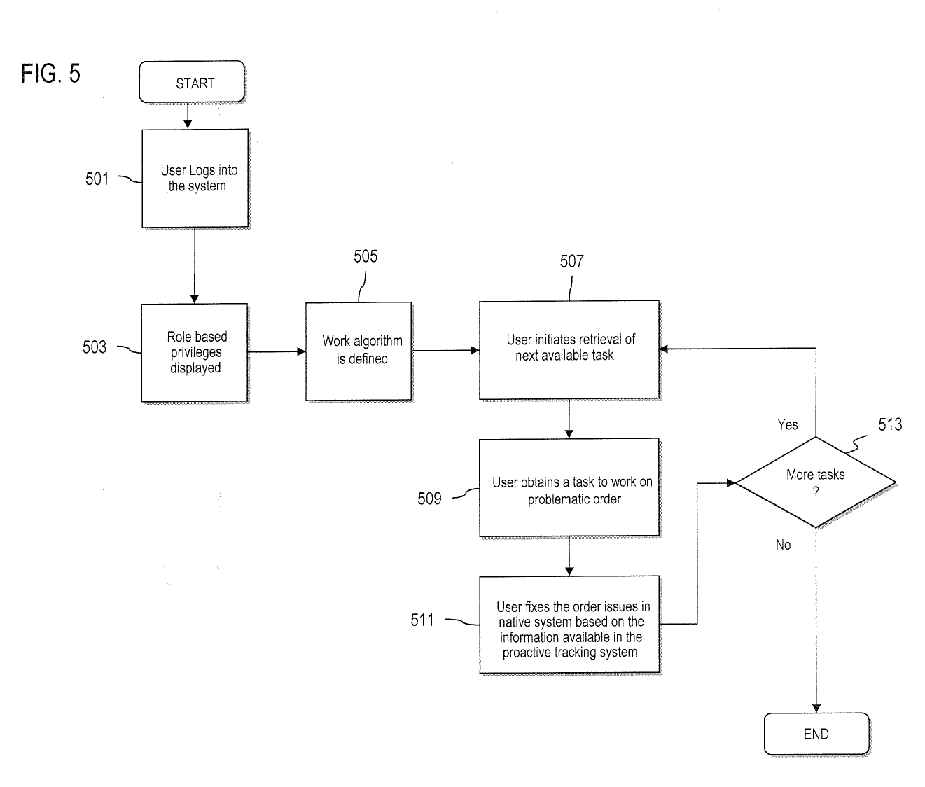

FIG. 5 is a flowchart of a process for handling service orders, according to an exemplary embodiment. For the purposes of illustration, the monitoring process is now described from the user's perspective (e.g., a support team member). For instance, a user of the dispatch team 107n initially logs into the monitoring system 103, in step 501, using a graphical user interface (GUI). According to one embodiment, the GUI employs standardized protocols, e.g., HyperText Transfer Protocol (HTTP), and computing languages, such as eXtensible Mark-up Language (XML). The privileges of the user based on his/her role are then displayed on the screen of the user, as in step 503. Based on their role configuration, a user can perform various tasks. The user can define algorithms to receive work items periodically (e.g., hourly, daily, etc.) via the work distribution engine 315 of FIG. 3. When a user wants to work on tasks based on the algorithm assigned to them, the system pushes and assigns the task to the user to fix (or otherwise resolve) the issue with the order so that the order meets, for example, a due date commitment provided by the service provider to the customers.

The work algorithm is defined next in step 505. The algorithm is essentially a set of rules that are defined using the work distribution engine 315 of FIG. 3. These algorithms are assigned to users to distribute the tasks associated with orders with issues.

The user then initiates, by selecting an appropriate button or icon on the GUI, retrieval of the next available task, per step 507. Next, the user receives the task on which to work on, as in step 509. In step 511, the user proceeds to investigate to determine why the order has not successfully progressed through the workflow. For example, the user can address the issues associated with order in the native system based on information available in the proactive tracking system 113. In doing so, the user can update the task with appropriate remarks and actions such as closing the action or putting the task on hold as per the business requirement. In one embodiment, the task or the exception item can be automatically closed with appropriate remarks, if the order moves to another milestone before a user closes the task. This avoids having users review a task if there are no issues on the orders.

In step 513, the process determines whether more tasks are available; if so, steps 507-511 are repeated until all tasks are addressed or otherwise closed.

As evident from the above description, the proactive monitoring processes detect non-occurrence of successful movement or progression through the workflow during specific timeline or reference events, thus eliminating blind spots that exist with traditional reactive approaches.

The above described processes relating to proactive monitoring of workflows may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

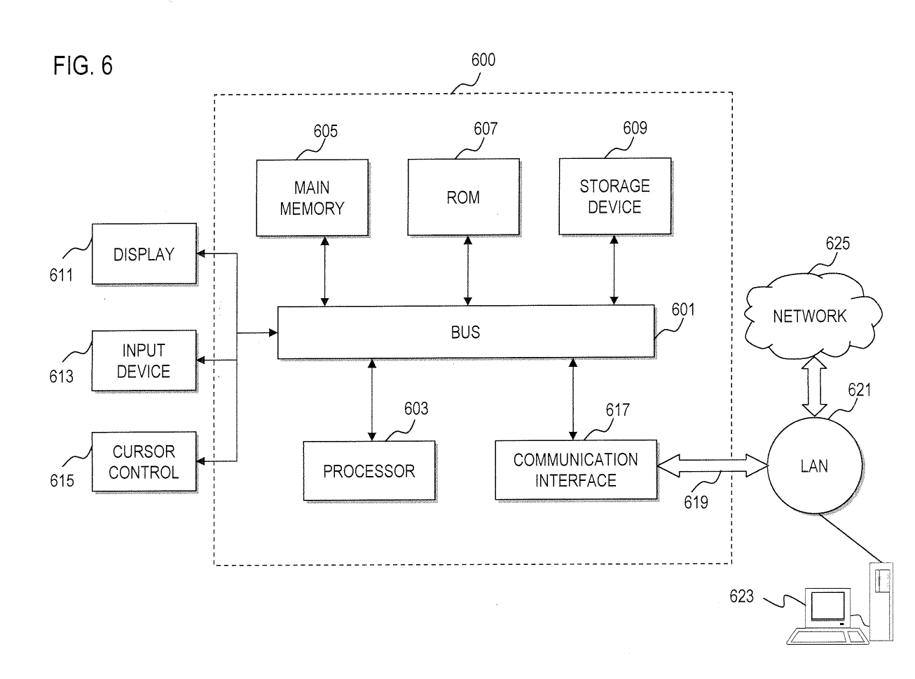

FIG. 6 illustrates a computer system 600 upon which an exemplary embodiment can be implemented. For example, the processes described herein can be implemented using the computer system 600. The computer system 600 includes a bus 601 or other communication mechanism for communicating information and a processor 603 coupled to the bus 601 for processing information. The computer system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computer system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computer system 600 may be coupled via the bus 601 to a display 611, such as a cathode ray tube (CRT), liquid crystal display, active matrix display, or plasma display, for displaying information to a computer user. An input device 613, such as a keyboard including alphanumeric and other keys, is coupled to the bus 601 for communicating information and command selections to the processor 603. Another type of user input device is a cursor control 615, such as a mouse, a trackball, or cursor direction keys, for communicating direction information and command selections to the processor 603 and for controlling cursor movement on the display 611.

According to one embodiment of the invention, the processes described herein are performed by the computer system 600, in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the exemplary embodiment. Thus, exemplary embodiments are not limited to any specific combination of hardware circuitry and software.

The computer system 600 also includes a communication interface 617 coupled to bus 601. The communication interface 617 provides a two-way data communication coupling to a network link 619 connected to a local network 621. For example, the communication interface 617 may be a digital subscriber line (DSL) card or modem, an integrated services digital network (ISDN) card, a cable modem, a telephone modem, or any other communication interface to provide a data communication connection to a corresponding type of communication line. As another example, communication interface 617 may be a local area network (LAN) card (e.g. for Ethernet™ or an Asynchronous Transfer Model (ATM) network) to provide a data communication connection to a compatible LAN. Wireless links can also be implemented. In any such implementation, communication interface 617 sends and receives electrical, electromagnetic, or optical signals that carry digital data streams representing various types of information. Further, the communication interface 617 can include peripheral interface devices, such as a Universal Serial Bus (USB) interface, a PCMCIA (Personal Computer Memory Card International Association) interface, etc. Although a single communication interface 617 is depicted in FIG. 6, multiple communication interfaces can also be employed.

The network link 619 typically provides data communication through one or more networks to other data devices. For example, the network link 619 may provide a connection through local network 621 to a host computer 623, which has connectivity to a network 625 (e.g. a wide area network (WAN) or the global packet data communication network now commonly referred to as the “Internet”) or to data equipment operated by a service provider. The local network 621 and the network 625 both use electrical, electromagnetic, or optical signals to convey information and instructions. The signals through the various networks and the signals on the network link 619 and through the communication interface 617, which communicate digital data with the computer system 600, are exemplary forms of carrier waves bearing the information and instructions.

The computer system 600 can send messages and receive data, including program code, through the network(s), the network link 619, and the communication interface 617. In the Internet example, a server (not shown) might transmit requested code belonging to an application program for implementing an exemplary embodiment through the network 625, the local network 621 and the communication interface 617. The processor 603 may execute the transmitted code while being received and/or store the code in the storage device 609, or other non-volatile storage for later execution. In this manner, the computer system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the various exemplary embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
monitoring for a non-occurrence of a successful movement by an object through a workflow that includes a plurality of activities; and
generating a task corresponding to the object to specify non-movement through the workflow.

2. A method according to claim 1, further comprising:
presenting a view of the object and information about timeline or milestones associated with the object.

3. A method according to claim 1, further comprising:
initiating investigation of the object from a last milestone of the workflow.

4. A method according to claim 1, further comprising:
analyzing data from an operation system that is configured to process the object; and
translating the data into a milestone within the workflow.

5. A method according to claim 1, further comprising:
receiving a user defined business rule; and
applying the business rule to the object.

6. A method according to claim 1, further comprising:
defining an assignment rule based on the task; and
assigning the task to an agent based on the assignment rule.

7. A method according to claim 1, further comprising:
determining a milestone associated with the object; and
closing the task if the milestone is satisfied.

8. A method according to claim 1, further comprising:
restricting a user from accessing information about the workflow based on an assigned role of the user.

9. A method according to claim 1, wherein the object is an order for a product or service.

10. A method according to claim 1, wherein the task specifies a time period in which the object has not moved from a point in the workflow to another point in the workflow.

11. A system comprising:
a monitoring engine configured to monitor for a non-occurrence of a successful movement by an object through a workflow that includes a plurality of activities; and
a task creation engine configured to generate a task corresponding to the object to specify non-movement through the workflow.

12. A system according to claim 11, further comprising:
an interface engine configured to present a view of the object and information about timeline or milestones associated with the object.

13. A system according to claim 11, wherein the monitoring engine is further configured to initiate investigation of the object from a last milestone of the workflow.

14. A system according to claim 11, further comprising:
a data analyzing engine configured to analyze data from an operation system that is configured to process the object, and to translate the data into a milestone within the workflow.

15. A system according to claim 11, wherein the monitoring engine is further configured to receive a user defined business rule, and to apply the business rule to the object.

16. A system according to claim 11, further comprising:
a work distribution engine configured to define an assignment rule based on the task, and to assign the task to an agent based on the assignment rule.

17. A system according to claim 11, further comprising:
a task management engine configured to determine a milestone associated with the object, and to close the task if the milestone is satisfied.

18. A system according to claim 11, further comprising:
a role based access engine configured to restrict a user from accessing information about the workflow based on an assigned role of the user.

19. A system according to claim 11, wherein the object is an order for a product or service.

20. A system according to claim 11, wherein the task specifies a time period in which the object has not moved from a point in the workflow to another point in the workflow.
